(19) United States
(12) Patent Application Publication
(10) Pub. No.: US 2006/0127086 A1
(43) Pub. Date: Jun. 15, 2006

(54) Suppression of power transients in optically amplified links

(75) Inventor: Michael Y. Frankel, Baltimore, MD (US)

Correspondence Address: OLDS, MAIER & RICHARDSON, PLLC, PO BOX 20245, ALEXANDRIA, VA, 22320-1245, US

(73) Assignee: CIENA CORPORATION

(21) Appl. No.: 11/297,385

(22) Filed: Dec. 9, 2005

Related U.S. Application Data
(63) Continuation-in-part of application No. 11/230,458, filed on Sep. 21, 2005.
(60) Provisional application No. 60/634,537, filed on Dec. 10, 2004.

(51) Int. Cl. H04B 10/08

(52) U.S. Cl. 398/19

(57) ABSTRACT

Exemplary embodiments of the invention are drawn to a method and apparatus for the suppression of power transients in optically amplified links. A fault is detected in a first optical signal propagating in a first direction. Upon detection of the fault, a second optical signal propagating in a second direction to the first direction can be switched so as to reverse second optical signal and to replace the at least a portion of first optical signal.

### CROSS-REFERENCE TO RELATED APPLICATIONS

This application claims priority under 35 U.S.C. § 120 on and is a Continuation-in-Part U.S. patent application Ser. No. 11/230,458 filed on Sep. 21, 2005 and claims priority under 35 U.S.C. § 119(e) on U.S. Provisional Patent Application No. 60/634,537 filed on Dec. 10, 2004. The disclosures of both are incorporated herein by reference in their entirety.

### BACKGROUND OF THE INVENTION

1. Field

Exemplary embodiments of the present invention generally relate to data transmission over fiber optic networks. More particularly embodiments of the present invention relate to the suppression of power transients in fiber optic networks.

2. Background

Current fiber-optic long-haul communication networks are predominantly comprised of point-to-point fiber-optic links. The data-modulated optical signals originate at one end and propagate through the fiber medium to the opposite end. While propagating through the fiber medium, the optical signals can suffer attenuation due to the scattering in the fiber medium, as well as losses in other components such as couplers, connectors and the like. To compensate for the loss, optical amplifiers can be placed at regular intervals along the fiber span, typically 40 to 100 km apart. A single fiber strand can carry many independent multiple optical signals (e.g., >100), each signal being differentiated by a slightly different wavelength (e.g., 0.4 nm separation). Accordingly, optical amplifiers amplify all the wavelengths simultaneously. As is known in the art, it is common for the optical amplifiers to be operated in a saturated mode having a fixed total optical power output, but variable gain.

More recently, optical communication networks have started to evolve away from simple point-to-point links. The first step was the introduction of fixed optical add-drop multiplexers (OADMs). The OADMs can be positioned at intermediate points along the fiber-optic link between the terminal ends, and provide the capability for adding or dropping individual wavelengths. This diversity of signal origination and termination points allows for more flexible and useful optical network architectures. A second evolutionary step was the addition of dynamic OADM capability, such that individual optical wavelength signals can be dynamically switched and rerouted between various fiber-optic links.

However, both of the above scenarios create a problem in controlling optical power in each wavelength. As previously mentioned, optical amplifiers are commonly operated such that they provide a fixed total output power (constant power mode), which is proportioned among the various wavelengths. This configuration provides an undesirable coupling mechanism among the optical wavelengths. Optical wavelength signals can appear and disappear in the fiber-optic link, either due to component failures and/or fiber cuts in the fixed OADM case, or due to active wavelength switching in the dynamic OADM case. As optical wavelength signals disappear, optical amplifiers operating in a constant power mode allocate the unused power to the remaining signals potentially causing a substantial increase in their power. Conversely, newly added optical wavelengths can cause substantial power drop in the already existing ones.

These optical power transients can be detrimental for several reasons. Optical power exceeding the receiver's dynamic range may cause loss of data on the low end and potential permanent component damage on the high end. Further, reduced optical wavelength power can cause signal to noise degradation and may result in a loss of data. Likewise, increased optical wavelength power can cause nonlinear signal distortions and noise and may result in a loss of data. Finally, optical power transients may disrupt seemingly unrelated parts of the network complicating alarm management and troubleshooting.

Additionally, the problem of channel loss exists. Channel loss can occur for several reasons in an optical network. For example, a fiber cut can occur between a first OADM and first optical line amplifier (OLA), which can cause a wavelength λ1 to be removed from the downstream optical amplifier chain. Poor connection quality, degradation or failure of components, and the like can also cause channel loss.

In one conventional system, the OLAs are held in constant total power mode in an attempt to prevent loss of data on channel/wavelength. In this system, the OLA pump power is held constant. Assuming a three channel system, if the second channel is lost, the available OLA output power is redistributed to the first and third channels, thereby proportionately increasing their power. However, fiber nonlinear effects may become detrimental to proper signal propagation, and data associated with these wavelengths may be lost.

In another conventional system, the OLAs are held in constant gain mode to prevent channel loss. OLA gain may be controlled via electronic feedback to the pump power, via optical feedback of a lasing wavelength, or other methods known in the art. In all cases, there is some finite error in gain in each amplifier associated with feedback circuit errors and response time, excited state absorption, and/or spectral hole burning, for example. Further, fiber nonlinear effects such as cross-channel Raman gain can substantially perturb the gain experienced by channels remaining in the system. Thus, remaining channel power can either increase or decrease in an unpredictable manner. If such deviations exceed the dynamic range of the system, data associated with these wavelengths will be lost.

As discussed above, conventional systems have tried to address the fiber cut/signal loss situation with electronic feedback that can control the gain of the amplifier. However, this type of feedback system merely attempts to compensate for the total power losses. In addition to the power loss, there is a concern of the actual channels/wavelengths lost. For example, an optical amplifier may have up to 192 channels. Since typical optical amplifiers tend to be broadband device, the loss of a particular portion of the spectrum can cause tilting in the amplified spectrum. Further, amplifiers are typically setup for a flat gain response across the spectrum and each amplifier in a particular path shares a similar configuration. Accordingly, the effect of the spectral tilt will tend to be amplified as the signal propagates to additional nodes, which may lead to spectral hole burning, for example.

To address this problem, some conventional systems have used “reservoir” channels to help and compensate for these potential effects. However, these reservoir channels are not identical to the lost channels and merely tend to distribute additional power across the spectrum. Further, reserving reservoir channels will reduce the amount of available channels for data propagation in a system.

Therefore, a need still exists for a system which provides a solution to the aforementioned data/signal loss problems in the conventional systems.

### SUMMARY OF THE INVENTION

Exemplary embodiments of the invention are drawn to methods and systems for the suppression of power transients in fiber optic networks.

Accordingly, an embodiment of the invention can include a method comprising: detecting a fault in a first optical signal propagating in a first direction; and switching a second optical signal propagating in a second direction to the first direction upon detection of the fault, so as to reverse the second optical signal and to replace at least a portion of the first optical signal.

Another embodiment of the invention can include an optical node comprising: monitor logic configured to detect a fault in a first optical signal propagating in a first direction; and switch control logic configured to switch a second optical signal propagating in a second direction to the first direction upon detection of the fault, so as to reverse the second optical signal and to replace at least a portion of the first optical signal.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an illustration of the system architecture in accordance with at least one embodiment of the present invention;

FIG. 2 is an illustration of the optical service channel architecture in accordance with at least one embodiment of the present invention;

FIG. 3 is an illustration of an apparatus in accordance with at least one embodiment of the present invention;

FIG. 4 is an illustration of an apparatus in accordance with at least one embodiment of the present invention;

FIG. 5 is an illustration of a failure mode in an optical network;

FIG. 6 is an illustration of an apparatus in accordance with at least one embodiment of the present invention; and

FIG. 7 is an illustration of a method in accordance with at least one embodiment of the present invention.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The expression communicates, coupled, connection, and connected as used herein refers to any connection, coupling, link and the like by which signals carried by one system element are imparted to the communicating element. Further, the devices described are not necessarily directly connected to one another and may be separated by intermediate components or devices.

The term “service channel” as used herein refers to a wavelength of an optical communication system such as a WDM, SONET or SDH-based system that is used to carry operational, administrative, maintenance, and/or provisioning information and is synonymous with “optical supervisory channel”, “OSC”, “optical service channel” or other industry terms that refer to these functions. A service channel may be “in-band” meaning that the service channel wavelength lies within the data wavelength transmission window of a WDM system (e.g., within the range of about 1500 nm-1590 nm). A service channel may also be “out-of-band” meaning that the service channel wavelength is outside the wavelength transmission window of the WDM system. Typically, the service channel signal is carried on a wavelength separate from those of the data signals (out-of-band). Examples of service channel wavelengths include, but are not limited to, 1310 nm, 1510 nm and 1625 nm in typical fiber-optic communication systems.

The term “service channel modem” as used herein refers to any device capable of handling the transmission and receipt of a service channel. More specifically, service channel modems handle a service channel that is optically added/multiplexed onto the same fiber as the WDM data signals, using wavelength-multiplexing filters or equivalent. After propagating through an optical fiber link, the service channel signal is optically dropped/demultiplexed from the data signals using wavelength-selective filters or equivalent and detected by an optical receiver in the downstream service channel modem.

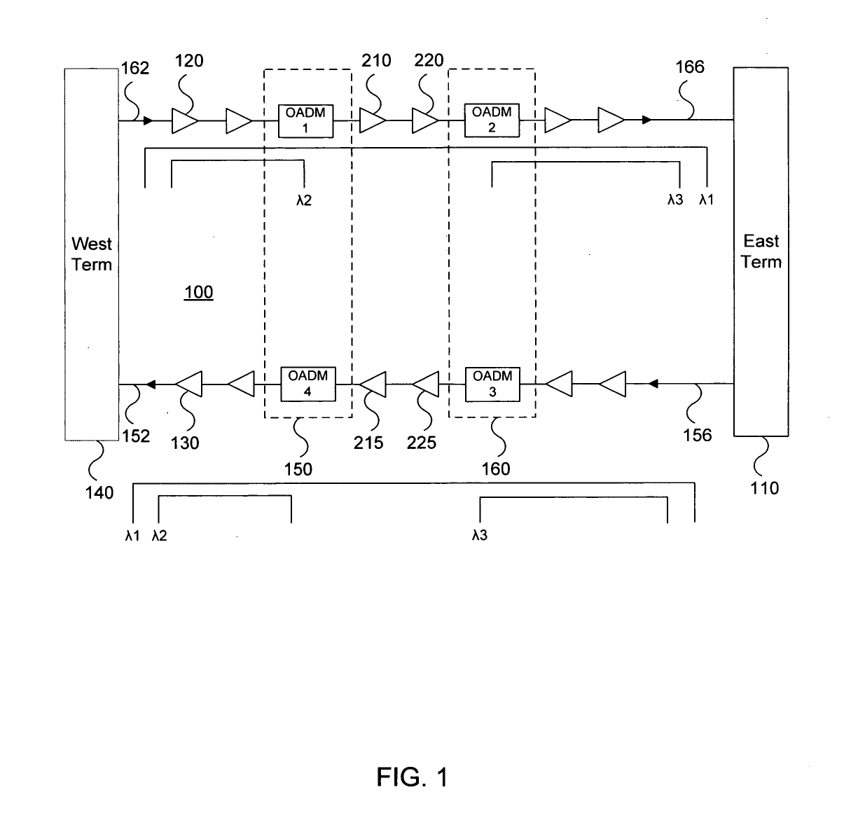

FIG. 1 illustrates an optical network architecture that can be used in at least one embodiment of the invention. Generally, information flows through a series of nodes/network elements in the network from one location or site to another. FIG. 1 illustrates a system 100 that has an East 110 and West 140 terminal. The East 110 and West 140 terminals communicate via lines (e.g., optical fiber pairs) that run between the terminals, as illustrated (e.g., lines 152 and 162). East 110 and West 140 terminals can be located a significant distance apart. Accordingly, line amplifier nodes or OLAs (e.g., 120, 130) can be interposed between the terminals (e.g., every 40-100 kilometers) to compensate for the signal loss in the transmission medium (e.g., optical fiber) by amplifying the signal. Additionally, OADMs can be located between the terminals to allow wavelengths to be added and/or dropped as desired, as is known in the art. Further, those skilled in the art will appreciate that OADMs 1 and 4 and 2 and 3 may be separate components in separate nodes or combined in a common node and/or integrated into a common unit as indicated by elements 150 and 160. Accordingly, the invention should not be construed to be limited to the illustrated embodiments.

For example, as illustrated in FIG. 1, a wavelength λ1 is propagated between East terminal 110 and West terminal 140 in both directions. Wavelength λ2 is propagated from West terminal 140 and dropped at OADM 1 in the West to East (W-E) direction and added at OADM 4 and propagated to West terminal 140 in the East to West (E-W) direction. Likewise, wavelength λ3 is added at OADM 2 and propagated to East terminal 110 in the W-E direction and propagated from East terminal 110 and dropped at OADM 3 in the E-W direction. As previously discussed the intentional or unintentional addition and/or removal of channels can cause perturbations to the downstream optical amplifiers.

Those skilled in the art will appreciate that fiber-optic wavelength division multiplexed (WDM) communication networks are evolving to a mesh type network that is richly interconnected with all-optical add/drop nodes. Individual fibers carry a multiplicity of separate wavelengths (e.g. 192 channels/wavelengths), with each wavelength potentially having different ingress and/or egress points into the fiber. As wavelengths propagate and suffer losses, they are re-amplified in optical amplifiers, which provide a shared gain medium to all wavelengths simultaneously.

Such optical amplifiers are typically operated in constant total power mode, in which case a change in total wavelength count in the fiber will lead to substantial power changes in the remaining wavelengths as total power is redistributed. Such power changes are detrimental to signal propagation, as previously discussed. Likewise, as previously discussed, if the optical amplifiers are operated in constant gain mode, a reduction in the signal power without a channel/wavelength loss may cause a reduction in the signal quality because the amplifier does not adjust the gain to ensure adequate power.

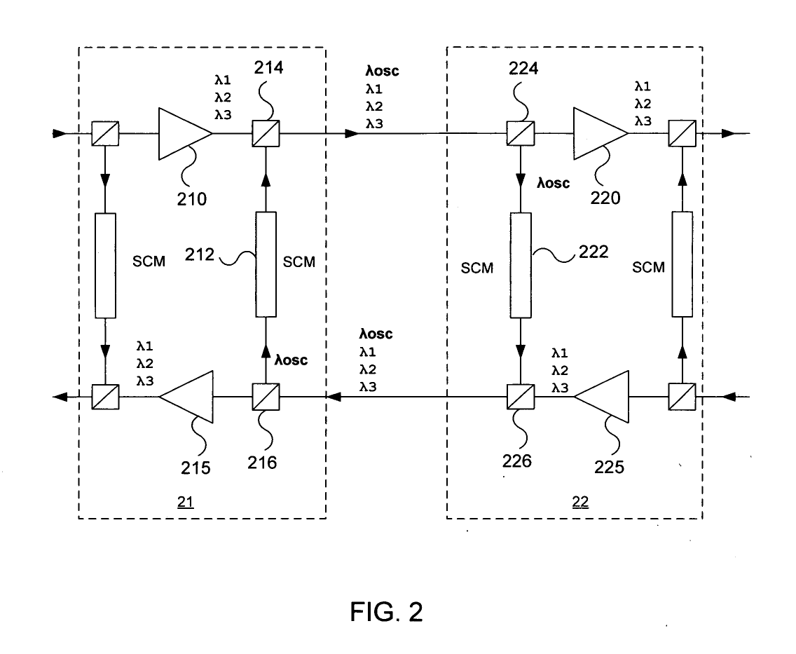

Optical Service channels can be used to communicate overhead/system information between nodes. As can be seen from FIG. 2, each service channel modem (SCM) (e.g., 212) receives its signal from one direction (e.g. East) and transmits it back to the sending node in the opposite direction (e.g., West). Accordingly, a pair of SCMs, one at each adjacent node (21, 22), can support a duplex/bidirectional communication link over the two-fiber span, as illustrated in FIG. 2. However, although two SCMs have been illustrated per node, a node may only have one SCM (e.g., at a border location, terminal position, head-end/tail-end node, etc.) Additionally, communication between SCM's at each node can be accomplished using a local bus or backplane in the node to allow information to be propagated to other nodes in the network. Further, since each SCM has a photo-receiver, controller and the like as is known in the art, each SCM can detect the upstream losses via a power measurement at each SCM, as is known in the art. Commonly owned U.S. Pat. No. 6,765,659 entitled “Optical Supervisory Channel Apparatus and Method for Measuring Optical Properties”, which is incorporated by reference herein in its entirety, provides additional details regarding using SCMs for power measurement.

As illustrated in FIG. 2, optical service channels typically bridge passive spans between optical amplifiers (e.g., 210, 220) and are independent of OLA operation. That is, the service channel modems (e.g., SCMs 212, 222) typically perform signal processing, compensation, decoding and/or amplification operations on the OSC. For example, as illustrated in FIG. 2, filter 216 drops the OSC wavelength (λosc) to SCM 212. The remaining W-E wavelengths (λ1, λ2, and λ3) are passed to amplifier 215. SCM 212 then propagates a wavelength λosc to the add filter 214, and it is then added to the W-E wavelengths (e.g., λ1, λ2, and λ3). The OSC is dropped at the other end via filter 224 to SCM 222 and is ultimately added to the E-W wavelengths, which completes the loop. Thus, the OSC experiences the same transmission medium as the other wavelengths but is not coupled to the amplifier nodes. Changes in or loss of a service channel can be one indication of a fiber cut or damage.

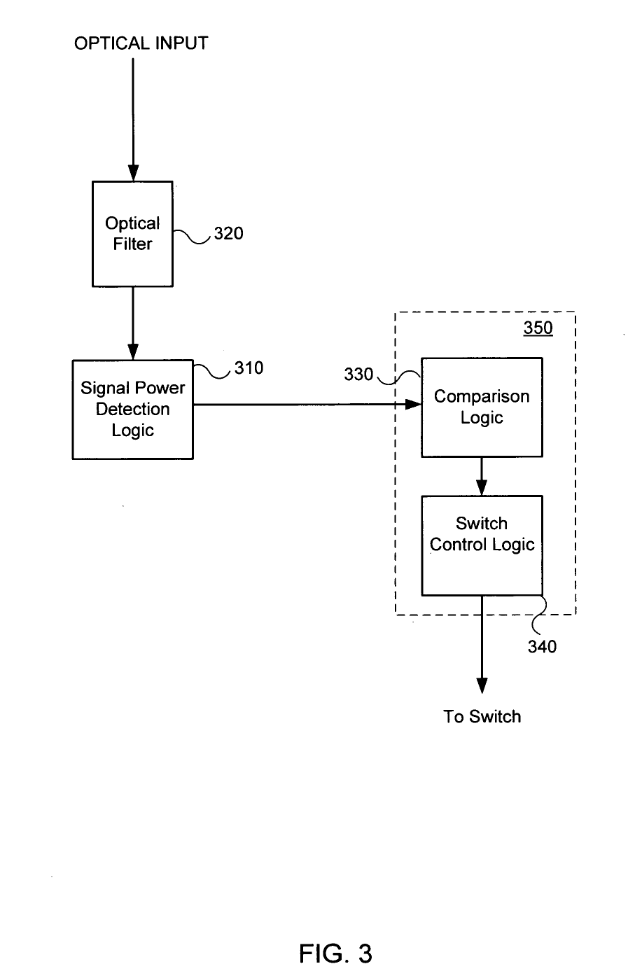

However, detection of channel loss may be accomplished in several ways. As illustrated in FIG. 3, an embodiment of the invention can include an apparatus having signal power detection logic 310 configured to detect signal power (e.g., either total signal power or selected channels). These signals can be detected after an optical filter 320 (e.g., filters 414, 424 in an OADM node discussed below). Detecting the signal power after a filter allows for selective attenuation of traffic channels and subsequent selective power detection. Alternatively, signal power detection logic 310 could be configured to detect the unfiltered input signals. Regardless of the source of the power measurement, comparison logic 330 can be configured to compare the power levels of the signals received and to signal the switch control logic 340 upon a detection of a fault. For example, the fault can be established as a measurement of the signal power that deviates from a baseline measurement, falls below a predefined power level, and the like. Further, switch control logic 340 can be configured to operate channel reversing functions at the node based on fault detection. Although FIG. 3 illustrates an example of monitor and switch control logic 350, the invention is not limited to this configuration and any system that detects channel loss can be used in embodiments of the invention. For example, a basic system can include a direct total power monitoring of the express path (e.g., channels traversing the node) immediately after the optical filter 320. Further, more complex fault detection methods may include additional optical filtering, combined with multi-channel power detection, albeit with increased cost and complexity. Additionally, a dead-zone threshold may be added to prevent small transients from triggering the switch event and disrupting the traffic. For example, a threshold may be set at a level that would correspond to a loss of a substantial portion or all traffic for the express channels (e.g., traffic channels traversing the optical node).

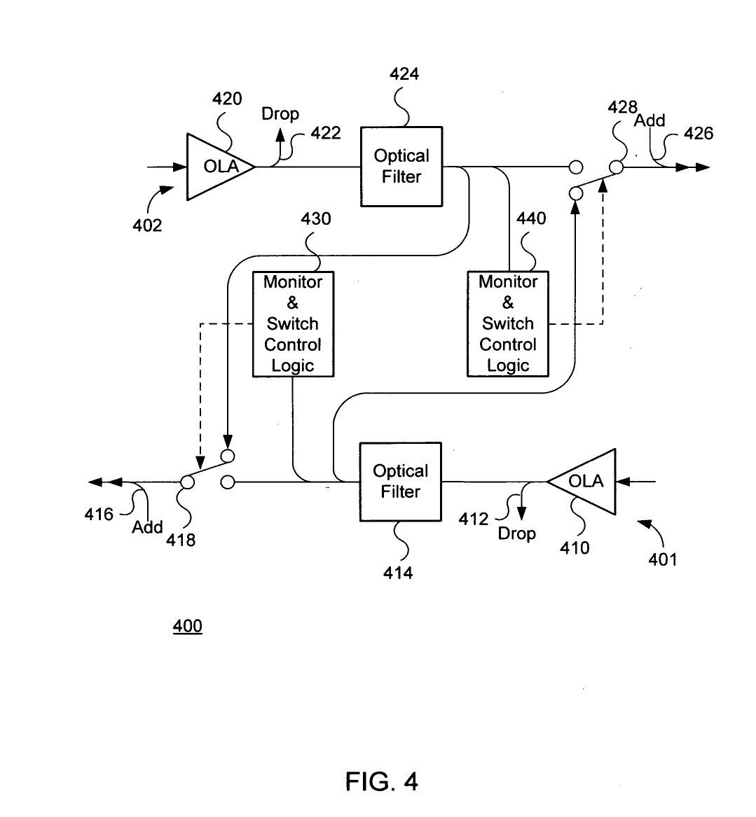

Embodiments of the present invention can provide substantially identical channels to the lost channels and thus eliminate or reduce the problems previously discussed. Embodiments of the present invention exploit the symmetry of channels propagating in typical bi-directional networks. That is, the East to West (E-W) channels typically are identical to the West to East (W-E) channels in both the wavelength and data rate, as will be appreciated by those skilled in the art. FIG. 4, illustrates an embodiment of the present invention, as incorporated into a typical optical add/drop multiplexer node (OADM) 400, 401, 402. As illustrated the OADM node can be considered each individual add/drop and supporting circuits (e.g., 401, 402) or may be considered to be the combination of multiple add/drops and supporting circuits (e.g., 400). However, embodiments of the invention is not limited to the illustrated configurations may be implemented in any system that can perform the functionality discussed herein. An OADM node 401, 402 can include an optical amplifier 410, 420 for restoring the level of the optical signals after link propagation. A drop path 412 is provided for directing wavelengths terminated at this OADM to receivers. An add path 416, 426 is provided for adding wavelengths originating at this node to the link. An optical filter 414, 424 is included to block the wavelengths dropped at this node, and allow for subsequent wavelength re-use.

As previously discussed it is assumed that East-West and West-East propagating channels/wavelengths are generally the same in optical networks. This is true for most symmetric optical networks, and the symmetry holds for bit rates, channel spacing, and relative channel power levels. An optical loop-back can be provided from the output of the optical filters 414, 424. If the monitor and switch control logic 430, 432 detects an optical power drop as would be associated with a channel count decrease, then optical loop-back path is closed via switch 418, 428 and channels propagating in one direction can be reversed. Thus, a direct substitution occurs for lost channels, keeping the overall spectral profile and power levels at a substantially identical level.

Detection of channel loss may be accomplished in several ways. The simplest is a direct total power monitoring of the express path immediately after the optical filter 414, 424. More complex methods may include additional optical filtering, combined with multi-channel power detection, albeit with increased cost and complexity. Additionally, a dead-zone threshold may be added to make sure that small transients do not trigger the switch event and disrupt the traffic. For example, the threshold may be set at a level that would correspond to a loss of traffic for the express channels (e.g., traffic channels traversing the optical node).

When original connectivity is restored, and the original data channels are operational, switch 418, 428 can be reverted back to their original state. If the restoration is performed gradually, power disturbances for downstream amplifiers are minimized. Thus, the original system operation may be restored. Another approach can include controllably and gradually reducing the reversed channel count, while also adjusting the optical amplifiers to accommodate the new channel count. When the reversed optical path is reduced to zero channels, switch 418, 428 may be restored its original state.

Channel addition can be controlled in a couple of manners. For example, addition can be made sufficiently slow as to not to perturb the system. Alternatively, OLAs may be operated in a mixed mode, such that OLAs react as constant gain if input power increases, but constant power if input power decreases. Further, the OLAs can treat all power decrease as if loss increased in a preceding span and correct for spectral tilt accordingly.

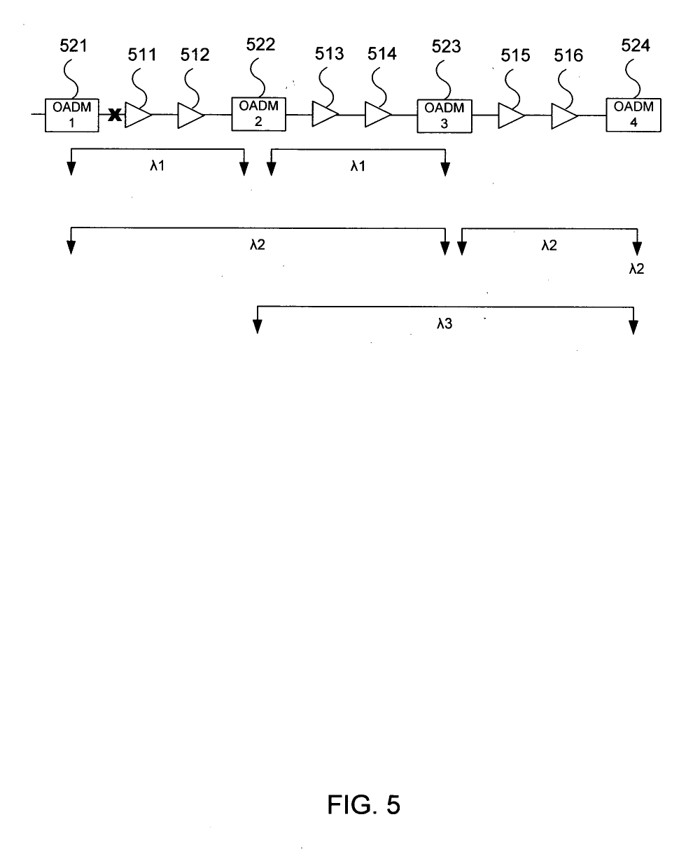

As an example, consider an optical network, as shown in FIG. 5. The network includes several optical add/drop multiplexers (OADMs) 521, 522, 523, 524 interconnected by optical links. The optical link loss is overcome by periodic optical line amplifiers (OLAs) 511, 512, 513, 514 515, 516. FIG. 5 also shows a set of possible wavelength connections established between OADMs. A multitude of connections is possible, and the ones shown are for illustration purposes only in the following failure scenarios.

In a first failure scenario, it is assumed that a channel loss occurs. Channel loss can occur for several reasons in an optical network, as discussed above. For example, a fiber cut can occur between OADM 521 and OLA 511. Wavelength λ2 is thereby removed from the amplifier chain between OADM 522 and OADM 523.

Using a conventional system response having the OLAs in constant power mode, the OLA pump power is held constant. Since λ2 power is lost, the available OLA output power is redistributed to λ1 and λ3 between OADMs 522 and 523, thereby proportionately increasing their power. Fiber nonlinear effects may become detrimental to proper signal propagation, and data associated with these wavelengths may be lost.

For comparison purposes, the response of conventional systems will be examined first. Using another conventional system response, the OLAs can be held in constant gain mode. OLA gain may be controlled via electronic feedback to pump powers, via optical feedback of a lasing wavelength, and the like as known in the art. There is some finite error in gain in each amplifier associated with feedback circuit errors and response time which can lead to excited state absorption, with spectral hole burning, and the like. Further, fiber nonlinear effects such as cross-channel Raman gain can substantially perturb the gain experienced by channels remaining in the system. Thus, remaining channel power can either increase or decrease in an unpredictable manner. If such deviations exceed the dynamic range of the system, data associated with these wavelengths will be lost.

However, in accordance with at least one embodiment of the invention having the OLAs in constant power mode, the OADM node can implement a channel reversal. Accordingly, λ2 propagating in the East-West direction would be reversed and re-injected into the West-East direction at OADM 522. The power in λ1 and λ3 wavelengths is held substantially constant. Data transmission is preserved in λ1 and λ3 wavelengths.

Channel addition is typically handled by the system in a gradual manner. In all cases, likelihood of system failure is minimal. However, operating OLAs in constant gain mode still may provide some additional margin over constant power operation.

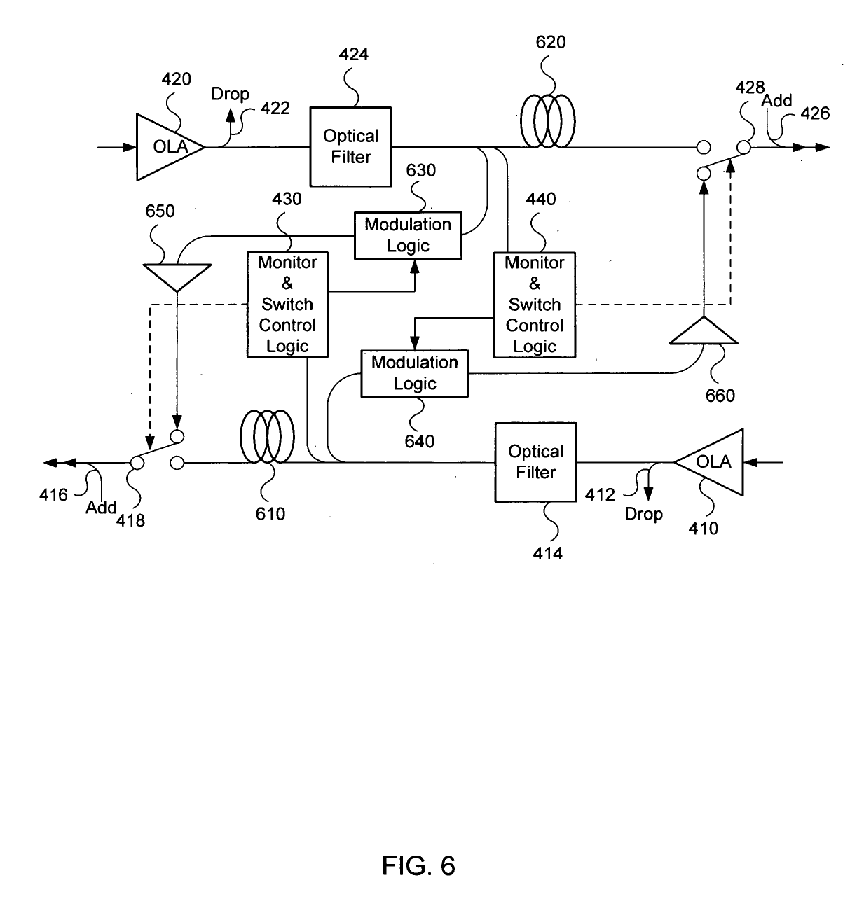

Since the Monitor and Switch Control logic (e.g., 430) has a finite response time. As illustrated in FIG. 6, in order to shorten the duration of the residual transient, optical memory 620, 630 may be introduced to delay the main signal path and align the switch response with the propagating signals. In the illustrated embodiment, optical memory 620, 630 is implemented as a fiber delay with ˜5 μs of delay per 1 km of fiber. However, those skilled in the art will appreciate that these values are merely for illustrative purposes and the invention is not limited to any specific type of delay element and/or delay time. Further, a more precise balance between lost and replaced channel powers may be achieved by introducing a variable gain element 650, 660 in the loop-back optical path, as illustrated in FIG. 6. Those skilled in the art will appreciate that the variable gain element can include both amplification and attenuation capabilities so that either a gain or loss can be added to the optical path.

Additionally, the Monitor and Switch Control logic 430, 440 can be enabled in the OADM immediately following a segment with the fiber cut. However, subsequent OADMs should be prevented from switching on any residual transient, since the channels have already been replaced in the preceding OADM. In one embodiment of the invention, a modulating signal (e.g., using Modulation logic 630, 640) may be superimposed onto the reversed channels for a period immediately after the transient event. Thus, subsequent OADMs will detect the modulation and recognize the transient event as one that has already caused channel reversal.

In another embodiment of the invention, since the signals are reversed in propagation through the network, they will necessarily arrive back at the same node as the transmitter. The information in the superimposed modulation may indicate the location of the network failure, and a head-end protection switch may be efficiently implemented, either at an optical or electrical layer. This can be beneficial for conserving bandwidth in mesh-protected networks. Further, the Modulation logic (e.g., 630, 640 in FIG. 6) may be used for a fast and efficient communication of failure information to the receiving OADM sites, which can facilitate rapid protection switching at the network layer.

In view of the foregoing disclosure, those skilled in the art will recognize that embodiments of the invention include methods of performing the sequence of actions, operations and/or functions previously discussed. For example, an embodiment of the invention can include a method comprising detecting a fault in a first optical signal propagating in a first direction; and switching a second optical signal propagating in a second direction to the first direction upon detection of the fault, so as to reverse second optical signal and to replace at least a portion of the first optical signal.

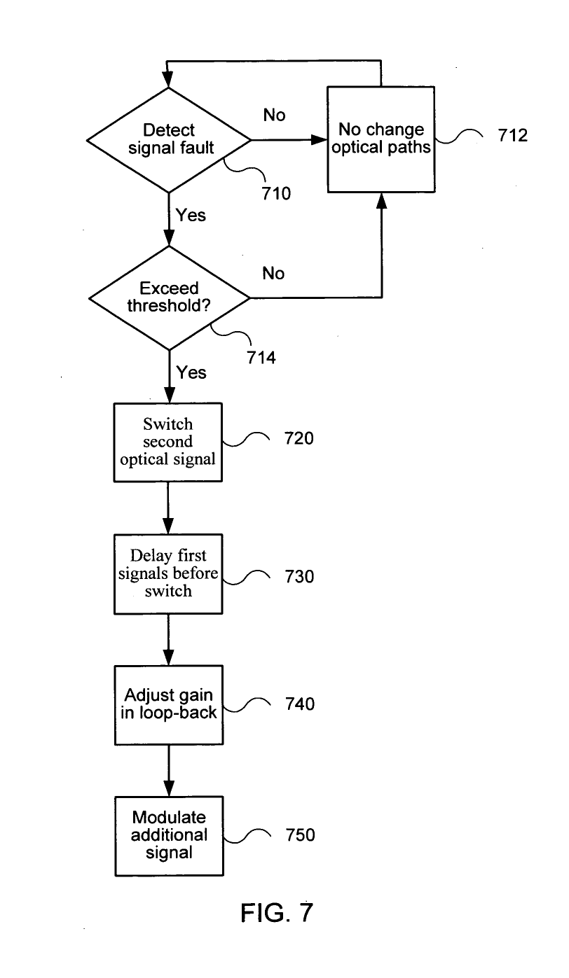

Referring to FIG. 7, a flowchart illustrating at least one method according to embodiments of the invention is provided. For example, the method can begin with the monitoring of the optical signals in 710. If a fault is not detected then there is no change to the optical paths, 712. However, upon detection of a fault (e.g, fiber cut, etc. as previously discussed) in the first optical signal received, then the second optical signal propagating in a second direction is switched to the first direction upon detection of the fault, so as to reverse second optical signal and to replace at least a portion of the first optical signal, 720. Replacing at least a portion of the first optical signal refers to signals that would propagate through the node and onto the next node, such as λ2 in FIG. 5. However, the signals may not be identical in that some channels may be dropped at the node and not propagated to the next node, so the second signal traveling in the opposite direction would not necessarily contain the dropped signals.

Additionally, the method can further include establishing a threshold for detecting the fault in the first signal to prevent spurious fault detection, 714. Further, the method can include delaying optical signals propagating in the first direction prior to an injection point of the second optical signal, 730. As discussed above, the delay can compensate for the finite detection and switching time. Additionally, as discussed above methods according to embodiments of the invention can include adjusting the gain of the second optical signal prior to injecting the second optical signal in the first direction, 740 and modulating an additional signal on the second optical signal prior to injecting the second optical signal in the first direction, 750.

The figures included herein are provided to explain and enable the invention and to illustrate the principles of the invention. Some of the activities for practicing the invention shown in the method block diagrams of the figures may be performed in an order other than that shown in the figures, or in some configurations may optionally be omitted altogether. For example, blocks 730, 740, and 750 do not need to be performed in the order illustrated or any particular order. Further, the actions in blocks 730, 740, and 750 can be performed with or without the other. For example, only the delaying function 730 may be implemented in one embodiment and the other functions 740, and 750 may not.

Further, embodiments of the invention are not limited to the illustrated to the configurations illustrated. For example, embodiments of the invention can be practiced in a ring type optical network, as opposed to the configuration illustrated in FIG. 1. Accordingly, instead of East and West terminals as illustrated, add/drop nodes, such as OADM 1, can be positioned at various locations around the ring to provide ingress and egress points to the network.

Those of ordinary skill in the art will appreciate that information and signals may be represented using any of a variety of different technologies and techniques. For example, data, instructions, commands, information, and signals that may be referenced throughout the above description may be represented by voltages, currents, electromagnetic waves, magnetic fields, optical fields, or particles, or any combination thereof. Those of ordinary skilled in the art will also appreciate that the various illustrative logical blocks, modules, circuits, and algorithm routines described in connection with the embodiments disclosed herein may be implemented as electronic hardware, computer software, firmware, or combinations thereof.

To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Practitioners of ordinary skill in the art will know to implement the described functionality in ways tailored to suit each particular application, but such implementation decisions should not be interpreted as causing a departure from the scope of embodiments of the invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, computer or state machine. A processor may also be implemented as a combination of computing devices, e.g., a combination of a DSP and a microprocessor, a plurality of microprocessors, one or more microprocessors in conjunction with a DSP core, or any other such configuration.

The activities of methods, routines or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor in such a manner that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Various modifications to the illustrated and discussed embodiments will be readily apparent to those of ordinary skill in the art, and the principles defined herein may be applied to other embodiments without departing from the spirit or scope of the invention. Thus, the present invention is not intended to be limited to the embodiments shown herein but is to be accorded the widest scope consistent with the principles and novel features disclosed herein.

In describing various embodiments of the invention, specific terminology has been used for the purpose of illustration and the sake of clarity. However, the invention is not intended to be limited to the specific terminology so selected. It is intended that each specific term includes equivalents known to those of skill in the art as well as all technical equivalents which operate in a similar manner to accomplish a similar purpose. Hence, the description is not intended to limit the invention.

Further, although the invention has been illustrated by reference to specific embodiments, it will be apparent to those skilled in the art that various changes and modifications may be made which clearly fall within the scope of the invention. The above description illustrates various embodiments of the invention, but, for the sake of clarity, does not provide a detailed explanation of each of the various changes and modifications which fall within the scope of the invention. Hence, the description is not intended to limit the invention. The invention is intended to be protected broadly within the scope of the appended claims.

What is claimed is:

1. A method comprising:
detecting a fault in a first optical signal propagating in a first direction; and
switching a second optical signal propagating in a second direction to the first direction in response to detection of the fault, so as to reverse the second optical signal and to replace at least a portion of the first optical signal.

2. The method of claim 1 further comprising:
establishing a threshold for detecting the fault in the first signal to prevent spurious fault detection.

3. The method of claim 2, wherein the threshold is established as a level corresponding to a loss of traffic for channels traversing through a node.

4. The method of claim 1, further comprising:
delaying optical signals propagating in the first direction prior to an injection point of the second optical signal.

5. The method of claim 4, wherein delaying optical signals propagating in the first direction comprises inserting an additional length of fiber to delay the optical signals.

6. The method of claim 1, further comprising:
adjusting the gain of the second optical signal prior to injecting the second optical signal in the first direction.

7. The method of claim 1, further comprising:
modulating an additional signal on the second optical signal prior to injecting the second optical signal in the first direction.

8. The method of claim 7, wherein the additional signal is configured to indicate a failure point to a node receiving the modulated additional signal.

9. The method of claim 8, further comprising:
initiating protection switching at the node receiving the additional signal.

10. The method of claim 1, wherein the first signal leaving an optical node in the first direction and the second signal entering the optical node in the second direction are substantially identical; and
wherein the first signal comprises a plurality of wavelengths and the second signal comprises a plurality of wavelengths.

11. An optical node comprising:
monitor logic configured to detect a fault in a first optical signal propagating in a first direction; and
switch control logic configured to switch a second optical signal propagating in a second direction to the first direction upon detection of the fault, so as to reverse the second optical signal and to replace at least a portion of the first optical signal.

12. The optical node of claim 11 further comprising:
logic configured to establish a threshold for detecting the fault in the first signal to prevent spurious fault detection.

13. The optical node of claim 12, wherein the threshold is established as a level corresponding to a loss of traffic for express channels.

14. The optical node of claim 11, further comprising:
optical memory configured to delay optical signals propagating in the first direction prior to an injection point of the second optical signal.

15. The optical node of claim 14, wherein the delay is on the order of 5 μs per 1 km of fiber.

16. The optical node of claim 11, further comprising:
a variable gain element configured to adjust the gain of the second optical signal prior to injecting the second optical signal in the first direction.

17. The optical node of claim 11, further comprising:
modulation logic configured to modulate a modulation signal on the second optical signal prior to injecting the second optical signal in the first direction.

18. The optical node of claim 17, wherein the modulation signal is configured to indicate a failure point to nodes receiving the modulation signal.

19. The optical node of claim 17, wherein the modulation signal is configured to initiate protection switching at a node receiving the modulation signal.

20. The optical node of claim 11, wherein the first signal leaving an optical node in the first direction and the second signal entering the optical node in the second direction are substantially identical; and wherein the first optical signal comprises a plurality of wavelengths and the second optical signal comprises a plurality of wavelengths.
